(19) United States
(12) Patent Application Publication
(10) Pub. No.: US 2003/0208678 A1
(43) Pub. Date: Nov. 6, 2003

(54) Media and multimedia data authentication and control method

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314

(73) Assignee: ERA DIGITAL MEDIA CO., LTD, Taipei (TW)

(21) Appl. No.: 10/201,899

(22) Filed: Jul. 25, 2002

(30) Foreign Application Priority Data
May 3, 2002 (TW) 091109270

(51) Int. Cl. H04L 9/00

(52) U.S. Cl. 713/168; 713/182

(57) ABSTRACT

The present invention is to provide a media and multimedia data authentication and control method, which is utilized in a server of a media program provider connected with at least one computer of consumer through a network, such that at least one multimedia data file supplied by the server is converted into an encrypted media file, and when the computer receives the encrypted media file via the network or other ways, the encrypted media file can be restored to an original unencrypted media file only by utilizing a decryption key obtained from the server through the network, therefore, the said publisher or provider controls the said decryption key and thereby precisely maintains control over multimedia data distribution to ensure proprietary rights and interests.

### BACKGROUND OF THE INVENTION

1) Field of the Invention

The invention herein relates to a media and multimedia data authentication and control method.

2) Description of the Prior Art

With the gradual increase in the popularity of the Internet in recent years, consumer on-line, downloading of various data has become a future trend of data distribution. The trend not only enables the distribution of various digital media products anywhere through the Internet, but the rapid on-line network sourcing of such products also makes possible digital media product counterfeiting. Moreover, since Internet global coverage is virtually unlimited, how to utilize media encryption technology to effectively prevent the copying of on-line digital media product and thereby protect the intellectual property rights of the said digital media products and, furthermore, also promote the concept of consumer payment as a universal value in order to perfect a workable on-line consumer mechanism appropriate for the coming multimedia age has already become an immediate concern in today's networked world and, furthermore, should be an important issue needed to be resolved.

Generally speaking, media program providers engaged in making the available and selectable viewing of media data are most loath to see situations in which their media content releases are unlawfully copied and widely circulated everywhere through the Internet, which does not only result in losses suffered by the said media program providers, but also rapidly undermines the concept that consumers should pay. Therefore, if the media content of every media file was accompanied by encryption processes and measures, while also supported by file management, on-line remittance, content delivering (including streaming and downloading). . . , and reasonable payment regulations (for example, stipulating the number of viewing times or time limit for a single payment), it is apparently that a secure, rational, and stable data exchange environment could be well established between the said media program providers and consumers.

Viewed from a technical perspective, media technology has progressed from stand-alone computer multimedia capability to on-line, real-time digital media services. Furthermore, whether graphics and sound effects or astounding transfer speed, the most important aspect is that integrated audio-video media software and hardware have become basic system accessories with highly developed ergonomic user interfaces. As a result, high quality on-line media information have become part of life and work. Not only do consumers easily obtain real-time and abundant information and entertainment, entrepreneurs find such information helpful for internal company training, management, and foreign trade business. For the said media providers, unlimited opportunities have resulted. Especially in recent years due to the particular attention to personal privacy and freedom, growing numbers of people are unwilling to line up at movie theaters, where they are crowded into a public place having bad air, small seats, and poor sanitation to view a movie among an audience of strangers and, furthermore, one has to admit that this is certainly not enjoyment, but perhaps better described as torment. Additionally, since audio-video media equipment and information products are continually advancing and finely integrated, their image and sound performance have reached a high state. Given the said factors, more people prefer enjoying optical disk or on-line real-time satellite programs while relaxing at home. However, one drawback is that most cannot enjoy the latest movies (such as movies currently premiering in theaters) via network in real-time. As a result, how to establish a mechanism or method that enables audiences at home to view movies through a network payment method has become an important objective among the said media program providers.

At present, a network-based pay per view arrangement provides for the distribution of movies or songs by network and television companies, with nearly 99 percent of the media files still not encrypted. Utilizing a hidden URL approach, after a consumer submits payment over a network, the consumer connects to the said media files. However, to watch pay per view media content at no charge, the method is quite easy; an extensive engineering background or high-level programming skills are not necessary because copying movies and songs is not difficult. For example, MPEG Audio Layer-3 (MP3) is a currently popular sound file compression format. Consumers often download such audio files and willfully record the said audio files onto optical disk, give them to friends, email them as attachments, transfer them to others, and even sell them, which is truly serious and, furthermore, a ruthless blow to intellectual property rights protection.

### SUMMARY OF THE INVENTION

In view of the non-encryption of nearly 99 percent of the media files for movies and songs available through network-based pay per view networks and television companies, the use of a hidden URL approach, and the relative ease of large-scale copying as well as unlawful distribution of media content over networks by consumers following submittal of payment, the inventor of the invention herein on behalf of the intellectual property concept and the present needs of a networked world conducted long-term research and experimentation that culminated in the successful development and design of a media and multimedia data authentication and control method, wherein after a media file is converted into an encrypted media file, it can only be restored to an original unencrypted media file by utilizing a decryption key possessed by the publisher or provider of the said encrypted media file and, therefore, the said publisher or provider controls the said decryption key and thereby precisely maintains control over multimedia data distribution to ensure proprietary rights and interests.

The objective of the invention herein is to utilize its method of encryption, authentication, and control mechanism to thereby further improve the protection of the rights and interests of authors, publishers, and media program providers, while also effectively preventing networking consumers who following payment submittal via network from opportunistically and willfully copying, giving away, or selling downloaded data and possible regretful encounters with the law, thereby achieving the objectives of effectively protecting intellectual property rights and stopping unlawful infringement.

Another objective of the invention herein is if the said consumer prefers not to immediately enjoy a said media file after downloading, it can be stored in a computer hard drive or stored on a magnetic or an optical disk and then portably taken and run on any network-capable computer, wherein the said media file can be immediately enjoyed following payment over the network. As such, the consumer avoids having to wait during a lengthy download period, the consumer can choose when a movie is viewed, thereby affording flexibility, and the said media and multimedia data has advantageously portability.

### BRIEF DESCRIPTION OF THE DRAWINGS

FIG. 1 is a computer determination flowchart of the invention herein.

FIG. 2 is a diagram illustrating the encryption and decryption process of the invention herein.

### DETAILED DESCRIPTION OF THE INVENTION

Due to the continuous advance of network media file encryption technology in recent years, various pay per view media program providers (such as television and network companies) have promoted the pay per view concept by applying encryption technology to on-line and downloaded programs, protecting media content with encryption to prevent copyright infringement. However, what is media file encryption technology? Simply speaking, one type of technology is the addition of a coded key to a Windows media file such the said media file can only be opened through a decryption key (such as a Windows Media License). Therefore, acquiring the rights of the said media license places management in hands of the said media program providers, enabling the said media program providers control by means of the said media license to precisely handle the normal distribution of digital media data and, as such, ensure the rights of authors and publishers. The decryption key unlocking approach is possible in a number of forms. For example, when the user wants to open a file, unlocking is either automatic or based on user requirements, etc. However, multimedia data providers distributing interactively selected viewing and listening material are most reluctant to see situations in which consumers pay a subscription and later willfully duplicate, give away, or sell downloaded data, which not only results in major losses suffered by authors and publishers, but adversely impacts the public protection of intellectual property rights.

The invention herein addresses the said concept by researching and developing a multimedia data authentication and control method, the said method referring to the conversion of original multimedia files, i.e., media files, by a media program provider into encrypted media files through encryption processing procedures, such that when consumers obtain the said encrypted media files through local area networks, the Internet, or other ways and utilizes a computer to enjoy the content (such as movies or music), the said method enables the said computer to initiate connection to the server of the said media program provider via the Internet and start an authentication mechanism installed on the said server, wherein after the said server reads the correct identification data provided by the said computer utilized by the said consumer, a test and verification is executed and after the test and verification is completed with no errors, a decryption key is forwarded into the computer of the a said consumer, the said computer utilizing the said decryption key to execute decryption of the said encrypted media files, enabling the said encrypted media files to become restored to media files in their original state before encryption; as such, the said computer displays the said original unencrypted multimedia data content to provide for consumer enjoyment. Additionally, after a said consumer downloads the said media files but not for immediate enjoyment, they can be stored in the computer hard drive such that when later enjoyed, network login and downloading is not required, only network login and payment submission, following which the media files can be enjoyed at once or stored in a magnetic or optical disk and then portably taken to any network-capable computer for execution, and following network login and payment submission, the said media files can be immediately enjoyed; as such, this not only enables the said media program providers to have control over the usage conditions of the said multimedia data, but also the portability of the said multimedia data.

In the invention herein, each time the said server issues a decryption key, it is unique and, furthermore, recorded in the data base of the said server; therefore, the said media program providers have a detailed record regarding the utilization status of the said media files and, as a result, how the said consumers obtain the said media files (such as cases of unlawful pirate copying) is no longer an important question to the said media providers because all persons whatsoever enjoying the said media file contents are required to pay the said media program providers.

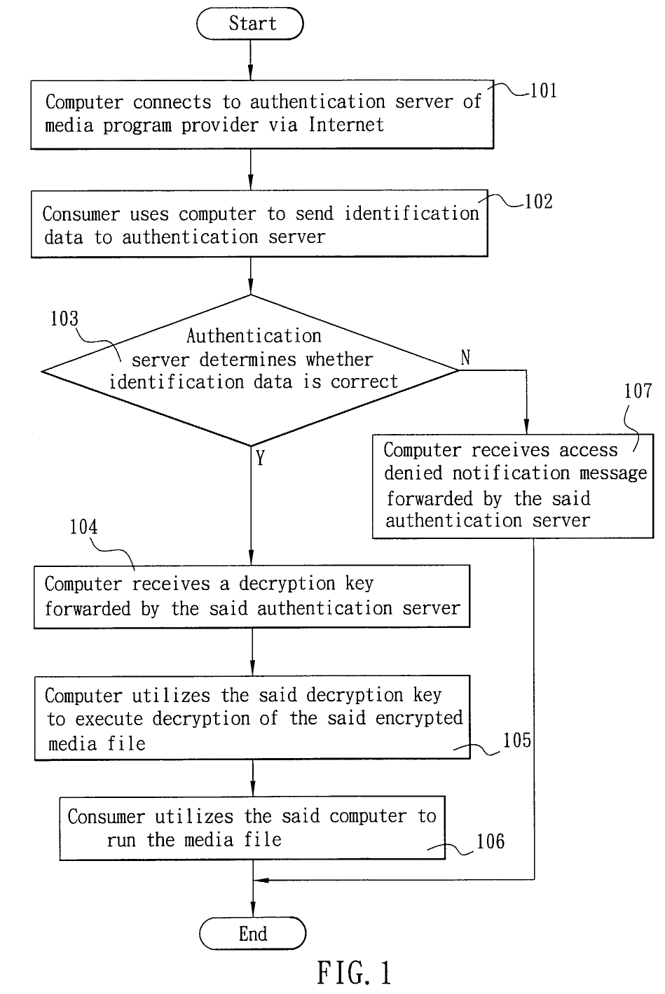

Given the preceding in-depth elaboration of the invention herein, the essential nature of the present invention is not difficult to comprehend, but to enable the examination committee a further understanding thereof, the exact procedures are listed below to explain the main points of the invention herein. In the invention herein, the said method is utilized between the server of a media program provider and the computer of at least one consumer, with the said computer connecting to the said server through a network such that at least one multimedia data file supplied by a said media program provider undergoes an encryption processing procedure and is respectively converted into encrypted media files, such that when the consumer obtains the said encrypted media file via the said network (local area network, the Internet) or other ways and utilizes a computer to enjoy the content (such as movies or music), as indicated in FIG. 1, the said method executes the processing of the following procedures:

(101) first, the said computer initiates a connection with the said server and starts an authentication mechanism installed on the said server.

(102) identification data inputted by the said consumer is then sent by the said computer to the said server, thereby providing for the executing of authentication by the said server.

(103) after the said server receives the said identification data, a determination is made as to whether the said identification data is correct; if so, step (104) is executed, otherwise, step (107) is executed.

(104) if the said identification data is determined to be correct, the said server forwards a decryption key to the said computer.

(105) the said computer utilizes the said decryption key to execute decryption of the said encrypted media file, enabling the said encrypted media file to become restored to a media file in its original unencrypted state.

(106) the said computer then runs the said media file and the content of the said media file is displayed on its screen for consumer enjoyment.

(107) when the said server does not find membership data matching the said identification data, the said server forwards an access denied message or a membership application request to the said computer.

It is not difficult to understand that the invention herein as explained in detail above is an outstanding contribution to intellectual property protection, with the essentials of the method and cognitive perspective of the present invention illustrated in another manner below.

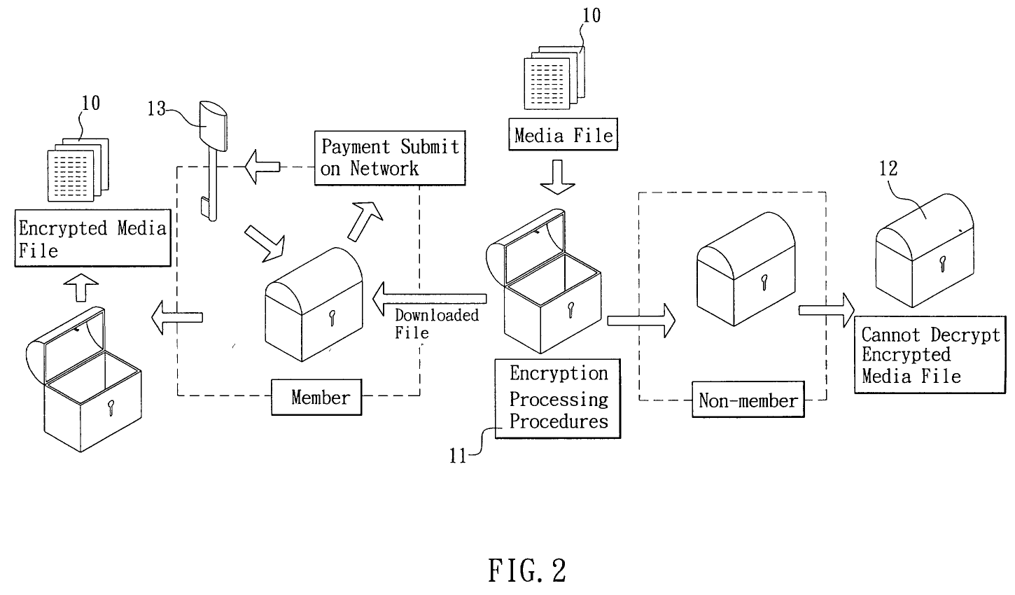

The technological concept of the invention herein, referring to FIG. 2, is as though the media file 10 is placed into a chest (the said media file 10 undergoes an encryption processing procedure 11), the said chest is locked (the said media file 10 is converted into the said encrypted media file 12) and then game rules are formulated to determine which person(s) can open the lock of the chest; as the parties formulating the said game rules are the said media program providers, any person acquiring the said chest is obligated to follow the game rules (for example, submit a fee over network, complete a questionnaire, and become a member, etc.) of the said media program providers before the said media program providers forward a license key (the decryption key 13) into consumer hands signifying abidance with the said game rules, enabling the said consumer to unlock the chest to obtain the said media file 10 (restore the encrypted media file 12 to an original, unencrypted media file 10).

As the said media file is in the process of encryption by the invention herein, the said media program providers can set limits applicable to opening to the said encrypted media file; for example, if the said media file is a movie, then the a said media program provider can stipulate how many times or days the said movie can be shown. When such a limit is reached, the said chest is automatically locked and the said consumer must once again adhere to the game rules designated by the said media program provider in order to be granted a new license key and since each license key issued by the said server is unique and all are recorded in the data base established in the said server, the said media program provider has a detailed record of the usage situation of the said encrypted media file and, as a result how the said consumer acquires the said media file is unimportant because any person wanting to use the said media file is definitely required to submit payment to the said media program provider.

To enable a further understanding and recognition of the invention herein by the examination committee, the following real life example is presented as a means of explanation.

A Mr. Lin of Taipei has perused the web page of a said media program provider, registered as a member of the said media program provider, and purchased 100 points of movie enjoyment, with the media provider stipulating that each instance of viewing a movie requires the subtraction of 10 points. Mr. Lin learns from the web page of the said media program provider that a latest movie is available for downloading so he downloads and stores the media file of the said movie in a computer. When Mr. Lin wants to view the said movie and runs the said movie media file, the said computer connects with the web page of the said media provider and a dialogue box requests the inputting of membership data. After Mr. Lin inputs the correct membership data, the said media program provider gives Mr. Lin the password 1234 and following the correct inputting of the said password into the said computer, the said computer runs the said media file, at which time Mr. Lin is allowed to enjoy the movie and 10 points are deducted for viewing the said movie.

In the said example, since the said media program provider has stipulated that 10 points be subtracted each time a movie furnished is viewed and, thus, deducts 10 points for the privilege, after Mr. Lin watches the said movie the first time and wants to see it a second time, when Mr. Lin runs the said media file, the said computer similarly connects to the web page of the said media program provider and Mr. Lin inputs the correct membership authentication data, following which the said media program provider gives Mr. Lin another password of 6543 (note that this password is different than the previous one), at which time Mr. Lin must correctly input the said password into the said computer in order to once again run the said media file and enjoy the said movie, Mr. Lin then having 80 points of movie enjoyment remaining.

If Mr. Lin wants to record the said movie on an optical disk or electronically transfer the file of the said movie to a Mr. Wang, when Mr. Wang runs the said file on his own computer, a connection to the web page of the said media program provider is established, but since Mr. Wang is not a member of the said media program provider, a dialog box request membership application or denies access. After Mr. Wang becomes a member and purchases points, a password such as 9876 is assigned and following inputting into his computer, the said movie is viewable. If Mr. Wang wants to send a said optical disk or electronically transfer its file to another person, since each password obtained is different, no matter how the said movie is duplicated or circulated, the said media program provider is relieved from copyright infringement perplexities because all persons wishing to enjoy the said movie must submit payment over the network.

In the said example, Mr. Lin stores the said movie on a hard drive after downloading it such that downloading anew at a later date is unnecessary; he only has to submit payment via network to immediately enjoy the said movie. Or, Mr. Wang can save the said file on a magnetic disk or record it onto an optical disk to portably run it on any network-capable computer, wherein the said movie is immediately viewable following network payment remittance. As such, the said media program provider not only has control over the usage situation of the said media file, but the said media file is of utmost portability.

The encryption technology in the said example utilizes a software company, digital rights management (DRM) mechanism, the said mechanism consisting of a technology that enables encryption and copyright management through a software movie format file. It is a type of server software utilized to ensure the secure distribution of copyrighted data or prevent unlawful distribution. DRM protection provides for the enforcement of mandatory payment for network data and content as well as stopping various pirating behavior. Due to copyright violations on networks, the major mission of DRM is the implementation of preventive measures such that network content theft is not possible. DRM products include server software and add-on programs for encryption, authentication, obtaining management personnel permission, and setting access limits, and other means to achieve DRM objectives.

1. A media and multimedia data authentication and control method, wherein the said method is utilized between a server of media program provider and at least one computer of consumer, with the said computer connecting to the said server through a network such that at least one multimedia data file supplied by a said media program provider first undergoes an encryption processing procedure and is respectively converted into an encrypted media file, such that when the consumer obtains the said encrypted media files via the said network or other ways and utilizes a computer to enjoy the content, the said method executes the processing of the following procedures:
first, the said computer initiates a connection with the said server and starts an authentication mechanism installed on the said server;
identification data inputted by the said consumer is then sent by the said computer to the said server, thereby providing for the executing of authentication by the said server;
after the said server receives the said identification data, a determination is made as to whether the said identification data is correct;
if the said identification data is determined to be correct, the said server forwards a decryption key to the said computer;
the said computer utilizes the said decryption key to execute decryption of the said encrypted media file, enabling the said encrypted media file to become restored to an original unencrypted media file;
finally, the said computer then runs the said unencrypted media file and the content of the said unencrypted media file is displayed on its screen for consumer enjoyment.

2. A media and multimedia data authentication and control method as claimed in claim 1 in which when the said server does not find membership data matching the said identification data, the said server forwards an access denied message to the said computer.

3. A media and multimedia data authentication and control method as claimed in claim 1 in which when the said server does not find membership data matching the said identification data, the said server forwards a membership application request to the said computer.

4. A media and multimedia data authentication and control method as claimed in claim 1 in which when the said server determines that the identification data is correct and error-free, the decryption key forwarded to the said computer is different from the decryption key issued during a previous instance.

5. A media and multimedia data authentication and control method as claimed in claim 1 in which the said network can be a local area network.

6. A media and multimedia data authentication and control method as claimed in claim 1 in which the said network can be the Internet.
